(19) United States
(12) Patent Application Publication
(10) Pub. No.: US 2017/0369604 A1
(43) Pub. Date: Dec. 28, 2017

(54) FINELY DIVIDED, CATIONIC, AQUEOUS POLYMER DISPERSIONS, METHOD FOR THE PRODUCTION THEREOF, AND THE USE THEREOF

(71) Applicant: BASF SE, Ludwigshafen (DE)

(72) Inventors: Carmen-Elena CIMPEANU, Ludwigshafen (DE); Klaus MOELLER, Mutterstadt (DE); Petra ARNOLD, Birkenau (DE); Kristina GEORGIEVA, Mannheim (DE); Juergen SCHMIDT-THUEMMES, Neuhofen (DE)

(73) Assignee: BASF SE, Ludwigshafen (DE)

(21) Appl. No.: 15/537,538

(22) PCT Filed: Dec. 16, 2015
(86) PCT No.: PCT/IB2015/059661

§ 371 Date: Jun. 19, 2017

(30) Foreign Application Priority Data
Dec. 19, 2014 (EP) 14199269.3

(51) Int. Cl. C08F 2/28; D21H 19/20; C08L 33/08; C08L 25/14; C08L 33/16; D21H 21/16; D21H 17/37

(52) U.S. Cl. CPC C08F 2/28; D21H 21/16; D21H 19/20; D21H 17/37; C08L 25/14; C08L 33/16; C08L 33/08; C08L 2201/50

(57) ABSTRACT

Finely divided, cationic, aqueous polymer dispersions, method for the production thereof, and the use thereof The present invention relates to a finely divided, cationic, aqueous polymer dispersion which is obtainable by emulsion polymerisation of ethylenically unsaturated monomers in a continuous phase containing an aqueous liquid in which the emulsion polymerisation is carried out, in the presence of polymerisation initiators, of a combination of monomers comprising (a) from 0 to less than 60% by weight of at least one optionally substituted styrene, (b) from greater than 0 to 80% of at least one C₁-C₁₂-alkyl acrylate and/or at least one C₁-C₁₂-alkyl methacrylate, (c) from 0 to 10% by weight of at least one ethylenically unsaturated monomer comprising at least one acid group, (d) from 5 to 20% by weight of at least one ethylenically unsaturated monomer comprising a cationic group, and (e) from 0 to 50% by weight of at least one non-ionic ethylenically unsaturated monomer differing from (a), (b), (c), and (d), the sum of (a)+(b)+(c)+(d)+(e) being 100% by weight, and the aqueous liquid contains from 0 to 4% by weight based on the weight of the combination of monomers of at least one emulsifier, in which the emulsion polymerisation is carried out optionally in the presence of at least one terpene containing compound. Also claimed is a process or preparing the finely divided, cationic, aqueous polymer dispersion and the use of the finely divided, cationic, aqueous polymer dispersion for sizing paper, board and cardboard.

The invention relates to finely divided, cationic, aqueous polymer dispersions which are obtainable by polymerisation of ethylenically unsaturated monomers in a continuous phase containing an aqueous liquid. The invention also relates to a process for the preparation of the polymer dispersions and their use as sizing agents for paper, board and cardboard.

U.S. Pat. No. 3,174,874 describes the surface sizing of paper by employing an aqueous dispersion of a cation active copolymer of 15 to 50% by weight based on the total weight of the copolymer of a heterocyclic compound bearing a single quaternary nitrogen atom in the nucleus in which the heterocyclic compound is selected from N- and C-vinyl substituted derivatives of imidazole, pyridine and quinoline, and 85 to 50% by weight based on the total weight of the copolymer, of difficulty water soluble ethylenically unsaturated monomers.

GB 1421597 refers to a process for the superficial sizing of paper involving the application of an aqueous solution of a water soluble copolymer of from 50 to 90% by weight of one or more alpha olefins of 2 to 12 carbon atoms and from 10 to 40% by weight of one or more mono-olefinically unsaturated monomers containing one or more tertiary or quaternary nitrogen atoms and from 0 to 20% by weight of one or more other olefinically unsaturated monomers. The copolymer has a K value of from 20 to 45.

US 2012/083563 relates to finely divided, cationic, aqueous polymer dispersions which are obtainable by a two-stage polymerisation. Firstly a cationic prepolymer is prepared as a dispersant and thereafter and emulsion polymerisation is carried out in an aqueous solution of this prepolymer in the presence of ethylenically unsaturated monomers. The polymer dispersions are used as sizes for paper, board and cardboard.

Chinese published patent application 103103878 describes a cationic surface sizing agent modified Sesbania gum and its method of preparation.

Chinese published patent application 102086614 teaches a surface sizing agent prepared employing silicones, cationic monomer, acrylate monomer, cross-linking monomer, and styrene.

Chinese published patent application 101871184 relates to a cationic styrene acrylate surface sizing agent. The preparation method employs styrene, methyl methacrylate, octadecyl acrylate, allyl alcohol and methacryloyl oxy ethyl trimethyl ammonium chloride in an emulsion polymerisation.

WO 12/132044 reveals a method for producing a cationic surface sizing agent involving a first step for obtaining a copolymer by solution polymerisation of a monomer mixture containing a monomer that has a tertiary amino group, a (meth) acrylic acid ester, and a styrene. In a second step the copolymer obtained in the first step and a non-ionic hydrophilic monomer is polymerised in a second step to obtain a further copolymer. In a third step this further copolymer is polymerised with a hydrophobic monomer in the presence of a surfactant. Finally in a fourth step the tertiary amino group present in the copolymer is quaternised.

Japanese published patent application 2009 242686 provides a cationic surface sizing agent prepared by polymerising a hydrophobic monomer in the presence of a copolymer of a tertiary amino group containing monomer, a (meth) acrylate ester type monomer and a styrene type monomer. The tertiary amino group in the copolymer is converted into a quaternary ammonium salt.

Chinese published patent application 102140768 teaches a cationic surface sizing composition which is prepared by including a natural macromolecule, a natural high molecule modifier, a hard monomer, a soft monomer, and a cationic monomer. Polymerisation is carried out with the aid of initiating agents and molecular control agents.

Cationic polymeric sizing agents are well known for providing paper, board and cardboard with good hydrophobicity. Typically, cationic surface sizes will often consist of a) a protective colloid which forms the outer hydrophilic shell or hydrophilic outer layer of each particle and b) a hydrophobic core. Often such cationic polymeric sizing agents are made in a two-step process in which a first protective colloid is prepared solution polymerisation followed by an aqueous emulsion polymerisation of hydrophobic monomers in the presence of the protective colloid.

Often the cationic component of such polymeric sizing agents are formed from amine monomers, such as dialkyl amino alkyl (meth) acrylates, dialkyl amino alkyl (meth) acrylamides. Such amine groups would be rendered cationic by maintaining an acidic pH such that the amine is protonated. However, such protonated amine polymers will lose their cationic charge in higher pH environments, for instance at a pH of above 7. This is disadvantageous because the sizing agent would then be no longer as efficient as sizing the surface of paper, board or cardboard.

Quaternary ammonium groups provide a more permanent cationic charge which would not be lost as the pH is raised. Nevertheless, it is generally more difficult to prepare copolymers of quaternary ammonium monomers with hydrophobic monomers and still produce polymer dispersions that are capable of achieving comparable sizing properties as polymer dispersions formed from tertiary amine or other free amine containing monomers.

According to the present invention we provide a finely divided, cationic, aqueous polymer dispersion which is obtainable by emulsion polymerisation of ethylenically unsaturated monomers in a continuous phase containing an aqueous liquid in which the emulsion polymerisation is carried out, in the presence of polymerisation initiators, of a combination of monomers comprising

(a) from 0 to less than 60% by weight of at least one optionally substituted styrene,
(b) from greater than 0 to 80% of at least one C₁-C₁₂-alkyl acrylate and/or at least one C₁-C₁₂-alkyl methacrylate,
(c) from 0 to 10% by weight of at least one ethylenically unsaturated monomer comprising at least one acid group,
(d) from 5 to 20% by weight of at least one ethylenically unsaturated monomer comprising a cationic group, and
(e) from 0 to 50% by weight of at least one non-ionic ethylenically unsaturated monomer differing from (a), (b), (c) and (d),
the sum of (a)+(b)+(c)+(d)+(e) being 100% by weight,
and the aqueous liquid contains from 0 to 4% by weight based on the weight of the combination of monomers of at least one emulsifier,
in which the emulsion polymerisation is carried out optionally in the presence of at least one terpene containing compound.

The finely divided, cationic, aqueous polymer dispersion according to the invention are distinguished by a significantly increased stability at pHs of above 7 while maintaining good or improved sizing effects in the production of paper, board and cardboard.

Monomers of group (a) are optionally substituted styrenes. This group includes styrene and substituted styrenes, such as, for example, α-methylstyrene, styrenes halogenated on the ring, such as chlorostyrene, or C₁-C₄-substituted styrenes, such as vinyltoluene. Of course, mixtures of optionally substituted styrenes can also be used. A preferred monomer of this group is styrene, which is preferably used alone from this group.

The monomers of group (a) are present in an amount of from 0 to less than 60% by weight, preferably from 10 to 50% by weight, more preferably from 15 to 50% by weight, and still more preferably from 15 to 45% by weight, in the reaction mixture comprising (a), (b), (c), (d) and (e).

Suitable monomers of group (b) are all esters of acrylic acid and of methacrylic acid which are derived from monohydric C₁-C₁₂-alcohols, such as methyl acrylate, methyl methacrylate, ethyl acrylate, ethyl methacrylate, n-propyl acrylate, n-propyl methacrylate, isopropyl acrylate, isopropyl methacrylate, n-butyl acrylate, n-butyl methacrylate, isobutyl acrylate, isobutyl methacrylate, tert-butyl acrylate, tert-butyl methacrylate, sec-butyl acrylate, sec-butyl methacrylate, n-pentyl acrylate, n-pentyl methacrylate, neopentyl acrylate, neopentyl methacrylate, cyclohexyl acrylate, cyclohexyl methacrylate, 2-hexyl acrylate, 2-hexyl methacrylate, 2-ethylhexyl acrylate, 2-ethylhexyl methacrylate, n-octyl acrylate, n-octyl methacrylate, isooctyl acrylate, isooctyl methacrylate, decyl acrylate and decyl methacrylate, dodecyl acrylate, dodecyl methacrylate, 2-propylheptyl acrylate and 2-propylheptyl methacrylate. Preferably useful monomers of this group are esters of acrylic acid and methacrylic acid with C₁-C₈-alcohols, such as methyl acrylate, methyl methacrylate, ethyl acrylate, n-propyl acrylate, isopropyl acrylate, n-butyl acrylate, sec-butyl acrylate, isobutyl acrylate, tert-butyl acrylate, cyclohexyl acrylate, 2-ethylhexyl acrylate and 2-ethylhexyl methacrylate. The esters of acrylic acid with C₁-C₄-alcohols, such as n-butyl acrylate, sec-butyl acrylate, isobutyl acrylate and tert-butyl acrylate are very particularly preferred.

According to the invention, at least one C₁-C₁₂-alkyl acrylate and/or C₁-C₁₂-alkyl methacrylate is used as a monomer of group (b), for example two or more of the abovementioned esters in any desired mixtures with one another. Preferably only one monomer from the group (b) is used as a monomer of the group and particularly preferably a monomer from the group consisting of the esters of acrylic acid with C₁-C₄-alcohols.

The monomers of group (b) are present in an amount of from greater than 0 to 80% by weight in the reaction mixture comprising (a), (b), (c), (d) and (e), typically from 1 to 80% by weight, preferably in amounts of from 10 to 75% by weight, more preferably in amounts of from 25 to 70% by weight, and suitably 30 to 70% by weight, for instance 35 to 70% by weight. In some cases it may be desirable to employ 30% or 35% to 65% by weight.

Examples of monomers of group (c) are ethylenically unsaturated C₃- to C₆-carboxylic acids, such as acrylic acid, methacrylic acid, maleic acid, fumaric acid, itaconic acid, ethacrylic acid, crotonic acid, monoesters of ethylenically unsaturated dicarboxylic acids, such as mono methyl maleate, mono methyl fumarate, mono ethyl maleate, mono ethyl fumarate, mono propyl maleate, mono propyl, fumarate, mono-n-butyl maleate, mono-n-butyl fumarate, and styrene carboxylic acids and ethylenically unsaturated anhydrides, such as maleic anhydride and itaconic anhydride. Depending on the water content of the solvent used in the polymerisation, the anhydride group of monomers may be hydrolysed to carboxyl groups. In addition, monomers comprising sulpho- and/or phosphonic acid groups, such as 2-acrylamido-2-methyl propane sulphonic acid and vinyl phosphonic acid, are suitable as monomers (c). The monomers comprising acid groups can be used in the form of free acid groups and in the form of partly or completely neutralised with alkali metal bases, alkaline earth metal bases, ammonia and/or amines. For example, sodium hydroxide solution, potassium hydroxide solution, sodium carbonate, sodium bicarbonate, ammonia, trimethyl amine, triethyl amine, morpholine, ethanolamine, diethanolamine, triethanolamine, or diethylene triamine is used for neutralising the acid groups of the monomers. It is of course possible to use two or more bases as neutralising agents.

From this group of monomers, acrylic acid and methacrylic acid or mixtures of acrylic acid and methacrylic acid in any desired ratio are preferably used. The monomers of group (c) are present in an amount of from 0 to 10% by weight in the reaction mixture comprising (a), (b), (c), (d) and (e). Desirably these monomers may be included in an amount of from 0.5 to 10% by weight, suitably from 1 to 7% by weight, for instance between 1.5 and 6% by weight. In some cases it may be desirable that monomers of component (c) are absent.

Monomers of group (d) are ethylenically unsaturated monomers which comprise at least one cationic group. Suitably such a cationic group may for instance be a sulphonium group or a phosphonium group, but preferably the cationic group is a quaternary ammonium group.

Suitable monomers of group (d) include ethylenically unsaturated esters or amides which carry a quaternary ammonium group. Typically such esters may have the formula (III)

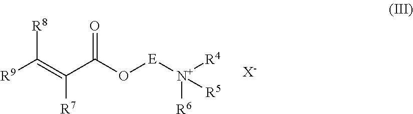

wherein R⁷, R⁸ and R⁹ are the same or different and are hydrogen or methyl, E is C₂₋₃-alkylene, R⁴, R⁵ and R⁶ are the same or different and are C₁₋₃-alkyl and X is a suitable anion, including methosulphate, halide or phosphate.

Examples of ethylenically unsaturated amides which carry a quaternary ammonium group may have the formula (IV)

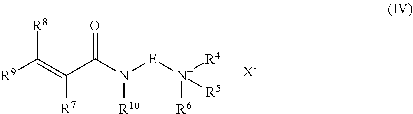

wherein R⁷, R⁸, R⁹, E, R⁴, R⁵, R⁶ and X have the meaning as indicated above, R¹⁰ is hydrogen or methyl.

Examples of C₂₋₃-alkylene are ethylene, trimethylene and propylene. Examples of C₁₋₃-alkyl are methyl, ethyl, propyl and isopropyl.

Preferred monomers include acryloyloxy ethyl trimethyl ammonium salts, including the chloride salt, and methacryloyl oxy ethyl trimethyl ammonium salts, including the chloride salt. Particularly preferred are acryloyloxy ethyl trimethyl ammonium salts, particularly the chloride salt.

Monomers of group (d) include, for instance, acrylamide-derived cationic monomer (Formula I) or acrylate-derived cationic monomer (Formula II) containing a hydrophobic chain and with the general formula:

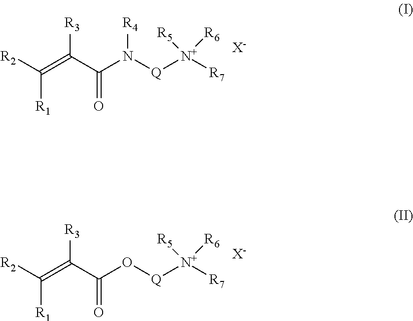

### Where:

R1, R2, R3, R4, R5, R6, independently, can be a hydrogen or an alkyl chain containing 1 to 4 carbons
Q: an alkyl chain containing 1 to 8 carbons
R7: an alkyl or alkenyl or arylalkyl chain containing 6 to 30 carbons
X: a suitable anion, including methosulphate, phosphate or a halide selected from the group including chloride, bromide, iodide, fluoride or another counterion with a negative charge.

A preferred structure for formula (I) is when R1=R2=R3=R4=H, which generates an acrylamide moiety. Another preferred structure is obtained when R1=R2=R4 and R3=CH3. Then a methacrylamide derivative is generated.

Similar to formula (I), a preferred structure for formula (II) is when R1=R2=R3=H, which generates an acrylate moiety. Another preferred structure is obtained when R1=R2=H and R3=CH3. Then a methacrylate derivative is generated.

Among all alkyl possibilities for Q, preferably Q is either an ethyl or a propyl group

Preferably, R5=R6 and are either methyl or ethyl moieties

For the substitute R7, preferred structures are hexyl, octyl, decyl, dodecyl, hexadecyl, octadecyl or benzyl.

Examples of preferred structures for the invention having the formula (I) are N-acrylamidopropyl-N,N,dimethyl-N-dodecyl ammonium chloride, N-methacrylamidopropyl-N,N,dimethyl-N-dodecyl ammonium chloride, N-acrylamidopropyl-N,N,dimethyl-N-dodecyl ammonium bromide, N-methacrylamidopropyl-N,N,dimethyl-N-dodecyl ammonium bromide, N-acrylamidopropyl-N,N,dimethyl-N-octadecyl ammonium chloride, N-methacrylamidopropyl-N,N,dimethyl-N-octadecyl ammonium chloride, N-acrylamidopropyl-N,N,dimethyl-N-octadecyl ammonium bromide, N-methacrylamidopropyl-N,N,dimethyl-N-octadecyl ammonium bromide, N-acrylamidopropyl-N,N,dimethyl-N-benzyl ammonium chloride, N-methacrylamidopropyl-N,N,dimethyl-N-benzyl ammonium chloride, N-acrylamidopropyl-N,N,dimethyl-N-benzyl ammonium bromide, N-methacrylamidopropyl-N,N,dimethyl-N-benzyl ammonium bromide.

Examples of preferred structures for the invention having the formula (II) are N,N-dimethylaminoethyl acrylate-N-dodecyl chloride, N,N-dimethylaminoethyl methacrylate-N-dodecyl chloride, N,N-dimethylaminoethyl acrylate-N-dodecyl bromide, N,N-dimethylaminoethyl methacrylate-N-dodecyl bromide, N,N-dimethylaminoethyl acrylate-N-octadecyl chloride, N,N-dimethylaminoethyl methacrylate-N-octadecyl chloride, N,N-dimethylaminoethyl acrylate-N-octadecyl bromide, N,N-dimethylaminoethyl methacrylate-N-octadecyl bromide, N,N-dimethylaminoethyl acrylate-N-benzyl chloride, N,N-dimethylaminoethyl methacrylate-N-benzyl chloride, N,N-dimethylaminoethyl acrylate-N-benzyl bromide, N,N-dimethylaminoethyl methacrylate-N-benzyl bromide

Another suitable category of ethylenically unsaturated monomers bearing cationic groups include diallyl ammonium compounds. Typically such compounds may have formula (V)

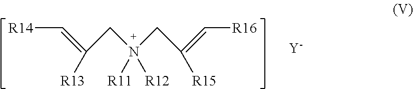

wherein
R₁₁ and R₁₂ independently are hydrogen or C₁-C₄ alkyl, hydroxyl C₁-C₄alkyl, carboxy C₁-C₄ alkyl, carboxyamide C₁-C₄alkyl, alkoxyalkyl group, wherein the alkoxyalkyl group is defined as having from 1 to 18 carbon atoms in the alkyl group;
R₁₃ and R₁₅ independently are hydrogen, methyl, ethyl or halogen;
R₁₄ and R₁₆ independently are hydrogen, C₁-C₆alkyl, or halogen; and
Y⁻ is an anion.
Y⁻ is preferably a halide.

The diallydialkyl ammonium salt is preferably a halide salt and the diallyldialkyl ammonium is a monomer of formula (V). Most preferably the diallydialkyl ammonium salt is diallyl dimethyl ammonium chloride (DADMAC).

A further category of suitable monomers of group (d) include cationic heterocyclic compounds which are substituted by an ethylenically unsaturated moiety. Particularly suitable compounds include N- or C-vinyl substituted heterocyclic compounds which contain only nitrogen atoms as hetero atoms in the nucleus, especially N-vinyl substituted derivatives of imidazole and C-vinyl substituted derivatives of pyridine of the general formula (VI) and general formula (VII):

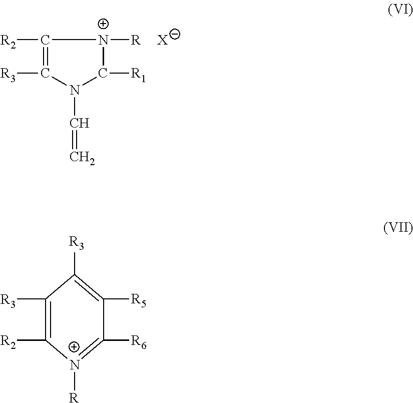

Wherein X^{⊖} is an anion, especially halide or alkyl sulphate radical, preferably one of the anions chloride, bromide, iodide, methyl sulphate, ethyl sulphate and propyl sulphate. R is an alkyl, cyclo alkyl or aralkyl radical, preferably methyl, ethyl, propyl, cyclohexyl or benzyl group, R₁ to R₆ is hydrogen and/or alkyl radicals with 1 to 3 carbon atoms, such as methyl, ethyl, propyl and/or isopropyl groups and additionally one of the substituents R₄ to R6 must be a vinyl group. The substituents R₂ and R₃ together may also be the radical —CH═CH—CH═CH—.

Suitable compounds include 1-methyl-2-vinyl pyridinium bromide and methosulphate, 1,2-dimethyl-5-vinyl-pyridinium methosulphate, 1-ethyl-2-vinyl-pyridinium chloride and bromide, 1-propyl-2-vinyl pyridinium chloride, 2-vinyl pyridinium ethyl sulphate, 1-benzyl-4-vinyl pyridinium chloride, N-vinyl-N′-ethyl imidazolium chloride, N-vinyl-N′-isopropyl-imidazolium chloride, 1-vinyl-3-methyl-benz-imidazolium metho sulphate, 1-methyl-2-vinyl-quinolinium metho sulphate and 1-benzyl-4-vinyl-quinolinium chloride. Preferred of these monomers is N-vinyl-N′-methyl imidazolium salts including the methosulphate salt.

Most preferred monomers of group (d) include firstly acryloyloxy ethyl trimethyl ammonium salts, including the chloride salt, also known as the methylchloride quaternary ammonium salt of dimethyl amino ethyl acrylate, and secondly N-vinyl-N′-methyl imidazolium salts particularly the methosulphate salt, also known as 3-methyl-vinyl-1H-imidazolium methyl sulphate.

It is preferred that when the monomer of group (d) is acryloyloxy ethyl trimethyl ammonium chloride that monomers of group (c) are included. Nevertheless it is preferred that when the monomer of group (d) is N-vinyl-N′-methyl imidazolium salts, such as the metho sulphate salt, that the monomers of group (c) are absent. It is also preferred that when the monomer of group (d) is a combination of N-vinyl-N′-methyl imidazolium salts, such as the metho sulphate salt, and acryloyloxy ethyl trimethyl ammonium chloride that the monomers of group (c) are absent.

Monomers of group (d) are present in the combination of monomers in an amount of from 5 to 20% by weight based on the weight of the total monomers (a), (b), (c), (d) and (e). Preferably, monomers of this group should be present in an amount of from 5 to 15% by weight. When monomers of group (d) are entirely acryloyloxy ethyl trimethyl ammonium salts, for instance acryloyloxy ethyl trimethylammonium chloride, a preferred range is 9 to 15% by weight based on the total combination of monomers (a), (b), (c), (d) and (e). When monomers of group (d) are entirely N-vinyl-N′-methyl imidazolium salts, such as the metho sulphate salt, a preferred range is 6 to 15% by weight based on the total combination of monomers (a), (b), (c), (d) and (e).

Monomers of group (e) comprise one or more non-ionic, ethylenically unsaturated monomers which are different from the monomers (a), (b), (c) and (d). Examples of such monomers are amides, such as, for example, acrylamide, methacrylamide, N-methyl acrylamide, N-methyl methacrylamide, N-ethyl acrylamide and N-ethyl methacrylamide; vinyl compounds, such as vinyl acetate, vinyl propionate or vinylformamide; C₁₋₃₀ alkyl (meth) acrylates. The alkyl moiety of the ester may contain between 1 and 9 carbon atoms, such as, for example, methyl acrylate, methyl methacrylate, ethyl acrylate, ethyl methacrylate, propyl acrylate, propyl methacrylate, isopropyl acrylate, isopropyl methacrylate, n-butyl acrylate, isobutyl acrylate, tert butyl acrylate, n-butyl methacrylate, isobutyl methacrylate, tert butyl methacrylate, hexyl acrylate, hexyl methacrylate, ethylhexyl acrylate, ethylhexyl methacrylate, cyclohexyl acrylate, cyclohexyl methacrylate. However, it may be desirable to employ esters in which the alkyl moiety as at least 10 carbon atoms, for instance between 10 and 24 carbon atoms. Suitable compounds include decyl acrylate, for instance n-decyl acrylate, decyl methacrylate, for instance n-decyl methacrylate, undecyl acrylate, undecyl methacrylate, dodecyl acrylate, for instance n-dodecyl acrylate (lauryl acrylate), dodecyl methacrylate, for instance n-dodecyl methacrylate (lauryl methacrylate), tridecyl acrylate, tridecyl methacrylate, tetradecyl acrylate, tetradecyl methacrylate, pentadecyl acrylate, pentadecyl methacrylate, hexadecyl acrylate, hexadecyl methacrylate, heptadecyl acrylate, heptadecyl methacrylate, octadecyl acrylate, such as n-octadecyl acrylate (stearyl acrylate), octadecyl methacrylate, such as n-octadecyl acrylate (stearyl acrylate), nonadecyl acrylate, nonadecyl methacrylate, cosyl acrylate, cosyl methacrylate, eicosyl acrylate, eicosyl methacrylate, docosyl acrylate, docosyl methacrylate, tricosyl acrylate, tricosyl methacrylate, tetracosyl acrylate, tetracosyl methacrylate or mixtures thereof. Alternatively the esters of acrylic acid or methacrylic acid having been prepared by reacting at least one ethylene oxide unit, for example hydroxyl ethyl methacrylate or diethylene glycol monomethacrylate. Other suitable monomers of this group include acrylonitrile and methacrylonitrile. It is of course also possible to use mixtures of said monomers.

If the monomers group (e) are used, they are present in an amount of up to 50% by weight, in general in an amount of up to 20% by weight, and normally no more than 10%, for instance in an amount of up to 5% by weight, based on the total amount of monomers (a) to (e) in the monomer mixture. Suitably these monomers may be included in an amount of from 0.5 to 5% by weight, for instance from 0.7 to 3.5% by weight, in the monomer mixture comprising monomers (a) to (e) in the monomer mixture. Preferably, monomers of group (e) are absent.

The sum of the values in % by weight for the monomers (a) to (e) is always 100.

Preferred finely divided, cationic, aqueous polymer dispersions according to the present invention are obtainable by the emulsion polymerisation of a combination of monomers comprising

(a) from 10 to 50% by weight of styrene,
(b) from 25 to 70% by weight of at least one C₁-C₁₂-alkyl acrylate and/or at least one C₁-C₁₂-alkyl methacrylate,
(c) from 0 to 10% by weight of at least one ethylenically unsaturated monomer comprising at least one carboxylic acid group,
(d) from 3 to less than 20% of at least one ethylenically unsaturated monomer comprising at least one quaternary ammonium group,
(e) from 0 to 20% by weight of at least one non-ionic ethylenically unsaturated monomer differing from (a), (b), (c), and (d),
the sum of (a)+(b)+(c)+(d)+(e) being 100% by weight,

More preferably the monomer mixture comprises:

(a) from 10 to 50% by weight of styrene,
(b) from 25 to 70% by weight of at least one C₁-C₄-alkyl acrylate and/or at least one C₁-C₄-alkyl methacrylate,
(c) from 0 to 10% by weight of acrylic acid or methacrylic acid,
(d) from 5 to 15% of at least one ethylenically unsaturated monomer comprising at least one quaternary ammonium group, selected from the group consisting of a quaternary ammonium salt of dialkyl amino alkyl acrylate, a quaternary ammonium salt of dialkyl amino alkyl methacrylate and a quaternary ammonium salt of N-vinyl imidazole, and
(e) from 0 to 10% by weight of at least one non-ionic ethylenically unsaturated monomer differing from (a), (b), (c), and (d),
the sum of (a)+(b)+(c)+(d)+(e) being 100% by weight.

A particularly preferred monomer mixture comprises:

(a) from 10 to 50% by weight of styrene,
(b) from 25 to 70% by weight of at least one C₁-C₄-alkyl acrylate and/or at least one C₁-C₄-alkyl methacrylate,
(c) from 1 to 10% by weight of acrylic acid or methacrylic acid,
(d) from 5 to 15% of a quaternary ammonium salt of dimethyl amino ethyl acrylate.
the sum of (a)+(b)+(c)+(d) being 100% by weight.

An alternative particularly preferred monomer mixture comprises:

(a) from 15 to 50% by weight of styrene,
(b) from 35 to 70% by weight of at least one C₁-C₄-alkyl acrylate and/or at least one C₁-C₄-alkyl methacrylate,
(d) from 5 to 15% of a quaternary ammonium salt of N-vinyl imidazole, optionally in combination with a quaternary ammonium salt of dimethyl amino ethyl acrylate.
the sum of (a)+(b)+(d) being 100% by weight.

Accordingly, preferred aqueous polymer dispersions are obtainable by the emulsion polymerisation is of a combination of monomers comprising

(a) from 10 to 50% by weight of styrene,
(b) from 25 to 70% by weight of at least one C₁-C₁₂-alkyl acrylate and/or at least one C₁-C₁₂-alkyl methacrylate,
(c) from 0 to 10% by weight of at least one ethylenically unsaturated monomer comprising at least one carboxylic acid group,
(d) from 3 to less than 20% of at least one ethylenically unsaturated monomer comprising at least one quaternary ammonium group,
(e) from 0 to 20% by weight of at least one non-ionic ethylenically unsaturated monomer differing from (a), (b), (c) and (d),
the sum of (a)+(b)+(c)+(d)+(e) being 100% by weight,
and the aqueous liquid contains from 0.5 to 3.5% by weight based on the weight of the combination of monomers of at least one emulsifier,
in which the emulsion polymerisation is carried out optionally in the presence of at least one terpene containing compound.

More preferred aqueous polymer dispersions are obtainable by the emulsion polymerisation is of a combination of monomers comprising

(a) from 10 to 50% by weight of styrene,
(b) from 25 to 70% by weight of at least one C₁-C₄-alkyl acrylate and/or at least one C₁-C₄-alkyl methacrylate,
(c) from 0 to 10% by weight of acrylic acid or methacrylic acid,
(d) from 5 to 15% of at least one ethylenically unsaturated monomer comprising at least one quaternary ammonium group, selected from the group consisting of a quaternary ammonium salt of dialkyl amino alkyl acrylate, a quaternary ammonium salt of dialkyl amino alkyl methacrylate and a quaternary ammonium salt of vinyl imidazole.
(e) from 0 to 10% by weight of at least one non-ionic ethylenically unsaturated monomer differing from (a), (b), (c) and (d),
the sum of (a)+(b)+(c)+(d)+(e) being 100% by weight.
and the aqueous liquid contains from 0.5 to 3.5% by weight based on the weight of the combination of monomers of at least one emulsifier,
in which the emulsion polymerisation is carried out optionally in the presence of at least one terpene containing compound.

Particularly preferred polymer dispersions are obtainable by the emulsion polymerisation is of a combination of monomers comprising

(a) from 10 to 50% by weight of styrene,
(b) from 25 to 70% by weight of at least one C₁-C₄-alkyl acrylate and/or at least one C₁-C₄-alkyl methacrylate,
(c) from 1 to 10% by weight of acrylic acid or methacrylic acid,
(d) from 5 to 15% of a quaternary ammonium salt of dimethyl amino ethyl acrylate.
the sum of (a)+(b)+(c)+(d) being 100% by weight.
and the aqueous liquid contains from 0.5 to 3.5% by weight based on the weight of the combination of monomers of at least one emulsifier,
in which the emulsion polymerisation is carried out in the presence of at least 0.01% by weight based on the weight of the combination of components (a)+(b)+(c)+(d) of at least one terpene containing compound.

An alternative particularly preferred polymer dispersion is obtainable by the emulsion polymerisation is of a combination of monomers comprising

(a) from 15 to 50% by weight of styrene,
(b) from 35 to 70% by weight of at least one C₁-C₄-alkyl acrylate and/or at least one C₁-C₄-alkyl methacrylate,
(d) from 5 to 15% of a quaternary ammonium salt of vinyl imidazole, optionally in combination with a quaternary ammonium salt of dimethyl amino ethyl acrylate.
the sum of (a)+(b)+(d) being 100% by weight.
and the aqueous liquid contains from 0.5 to 3.5% by weight based on the weight of the combination of monomers of at least one emulsifier,
in which the emulsion polymerisation is carried out in the presence of at least 0.01% by weight based on the weight of the combination of components (a)+(b)+(d) of at least one terpene containing compound.

For enhancing the dispersing effect, customary ionic, nonionic or amphoteric emulsifiers may be added to the polymerization batch. Customary emulsifiers are only optionally used. The amounts used are from 0 to 3% by weight and are preferably in the range from 0.02 to 2% by weight, based on the sum of the monomers (a), (b) and (c) used. Customary emulsifiers are described in detail in the literature, cf. for example M. Ash, I. Ash, Handbook of Industrial Surfactants, third edition, Synapse Information Resources Inc. Examples of customary emulsifiers are the reaction products of long-chain monohydric alcohols (C₁₀- to C₂₂-alkanols) with 4 to 50 mol of ethylene oxide and/or propylene oxide per mole of alcohol or ethoxylated phenols, or alkoxylated alcohols esterified with sulfuric acid which are generally used in a form neutralized with alkali. Further customary emulsifiers are, for example, sodium alkanesulfonates, sodium alkylsulfates, sodium dodecylbenzenesulfonate, sulfosuccinic esters, quaternary alkylammonium salts, alkylbenzylammonium salts, such as dimethyl-C₁₂- to C₁₈-alkylbenzylammonium chlorides, primary, secondary and tertiary fatty amine salts, quaternary amidoamine compounds, alkylpyridinium salts, alkylimidazolinium salts and alkyloxazolinium salts.

Suitable emulsifiers include for example sodium diethyl hexyl sulphosuccinate. This is available from BASF as Lumiten® I-SC.

Other suitable emulsifiers may be the emulsifiers used in accordance with the present invention comprise compounds having the formula

R—O—(CH₂—CH₂—O—)ₓH

in which R is an alkyl group of at least 12 carbon atoms, preferably a linear, saturated alkyl group of 16 to 18 carbon atoms, and x is at least 12, and preferably 18 and 80. More preferred emulsifiers include Lutensol® AT 18, Lutensol® AT 25, Lutensol® AT 50 and Lutensol® AT 80 all which are available from BASF SE.

In some cases it may be desirable to employ an emulsifier which comprises a polymerisable compound. Such a polymerisable compound may have the formula

R′(—O—CH₂—CH₂)ₓM

in which R′ is an alkyl group of at least one carbon atom, preferably between 1 and 22 carbon atoms, and M is a polymerisable moiety containing an ethylenically unsaturated group, preferably selected from acryloyloxy, methacryloyloxy, acrylamido, methacrylamido, and allyl ether.

Suitable polymerisable emulsifiers include Plex® 6954-O, which is a methacrylic ester of an ethoxylated C₁₆-C₁₈ fatty alcohol, available from Evonik; and Bisomer® MPEG 350 MA, which is a methoxy polyethylene glycol 350 methacrylate, available from GEO Specialty Chemicals.

The aqueous liquid contained in the continuous phase of the emulsion polymerisation contains from 0 to 4% by weight based on the weight of the combination of monomers of at least one emulsifier. Suitably the amount of at least one emulsifier should be from 0.05 to 4%, more suitably from 0.1 to 4%, for instance from 0.2 to 4%, typically from 0.5 to 4%. Particularly suitable amounts of the at least one emulsifier may be from 0.5 to 3.5%.

The finely divided, cationic, aqueous polymer dispersions according to the invention are obtainable by carrying out the polymerization optionally in the presence of at least one terpene-containing chain-transfer agent.

In the context of the present invention, terpene-containing chain-transfer agents are understood as meaning those hydrocarbons which are composed of isoprene units [H₂C=C(CH₃)—CH═CH₂] and can consequently be derived from the isoprene rule. Terpenes are divided into monoterpenes (C₁₀), sesquiterpenes (C₁₅), diterpenes (C₂₀), sesterterpenes (C₂₅), triterpenes (Cm) and tetraterpenes (C₄₀) and polyterpenes (>C₄₀), substantially into acyclic, monocyclic, bicyclic and tricyclic terpenes. Terpenes are known to a person skilled in the art, for example from Römpp Chemie Lexikon, 9th extended and revised edition, 1989-1992, Georg Thieme Verlag Stuttgart.

In the narrower sense, terpenes are understood as meaning hydrocarbons having a C₁₀H₁₆ skeleton, and the hydrogenation and dehydrogenation derivatives thereof and the alcohols, ketones, aldehydes and esters derived therefrom.

According to the invention, monocyclic monoterpenes are preferably used, particularly preferably diunsaturated monocyclic monoterpenes (so-called p-menthadienes). Examples of diunsaturated monocyclic monoterpenes are α-, β- and γ-terpinene, terpinolene, (+)-(S)-α-phellandrene, (−)-(S)-α-phellandrene and limonene. α-terpinene and terpinolene are preferred and terpinolene is particularly preferred.

Of course, mixtures of said terpene-containing chain-transfer agents can also be used, but preferably only one terpene-containing chain-transfer agent is used, particularly preferably only terpinolene is used.

The terpene-containing chain-transfer agents are used in the polymerization in an amount of at least 0.01% by weight, based on the monomers. The amounts depend substantially on the efficiency of the chain-transfer agent or chain-transfer agents used in each case. They are usually in the range from 0.01 to 10% by weight, suitably from 0.05 to 5.0% by weight, and preferably between 0.05 and 1% by weight, based on the monomers (a), (b), (c), (d) and (e).

In order to initiate the polymerization, a redox initiator is used according to the invention. Said redox initiators are preferably graft-linking, water-soluble redox systems, for example comprising hydrogen peroxide and a heavy metal salt or comprising hydrogen peroxide and sulfur dioxide or comprising hydrogen peroxide and sodium metabisulfite. Further suitable redox systems are combinations of tert-butyl hydroperoxide/sulfur dioxide, sodium or potassium persulfate/sodium bisulfite, ammonium persulfate/sodium bisulfite or ammonium persulfate/iron(II) sulfate. Preferably, hydrogen peroxide is used in combination with a heavy metal salt, such as iron(II) sulfate. Frequently, the redox system additionally comprises a further reducing agent, such ascorbic acid, sodium formaldehyde sulfoxylate, sodium disulfite or sodium dithionite. The redox initiators are used, for example, in an amount of from 0.05 to 10% by weight, preferably from 0.1 to 5% by weight, based on the monomers.

The invention also relates to a process for the preparation of the finely divided, cationic, aqueous polymer dispersions according to the invention by emulsion polymerisation of ethylenically unsaturated monomers in a continuous phase containing an aqueous liquid in which the emulsion polymerisation is carried out, in the presence of polymerisation initiators, of a combination of monomers comprising

(a) from 0 to less than 60% by weight of at least one optionally substituted styrene,
(b) from greater than 0 to 80% of at least one C₁-C₁₂-alkyl acrylate and/or at least one C₁-C₁₂-alkyl methacrylate,
(c) from 0 to 10% by weight of at least one ethylenically unsaturated monomer comprising at least one acid group,
(d) from 5 to 20% by weight of at least one ethylenically unsaturated monomer comprising a cationic group, and
(e) from 0 to 50% by weight of at least one non-ionic ethylenically unsaturated monomer differing from (a), (b), (c) and (d),
the sum of (a)+(b)+(c)+(d)+(e) being 100% by weight,
and the aqueous liquid contains from 0 to 4% by weight based on the weight of the combination of monomers of at least one emulsifier,
in which the emulsion polymerisation is carried out optionally in the presence of at least one terpene containing compound.

The aforesaid more precise embodiments are also applicable to the process.

The monomers can be polymerized by the emulsion polymerization method, either in the feed procedure or in the batch procedure. Preferably, an aqueous liquid, optionally containing emulsifier, and the monomers are added either separately or as a mixture and, separately therefrom, the oxidizing part of the redox initiator, preferably hydrogen peroxide, is added continuously or batchwise. A gradient procedure, which is disclosed in WO 2002/14393 A1, can also be used for the preparation of the finely divided, cationic, aqueous polymer dispersions.

The addition can be effected uniformly or nonuniformly, i.e. with changing metering rate, over the metering period.

The polymerization is usually carried out in the absence of oxygen, preferably in an inert gas atmosphere, e.g. under nitrogen. During the polymerization, thorough mixing of the components should be ensured. Thus, the reaction mixture is preferably stirred during the entire duration of the polymerization and of any subsequent postpolymerization.

The polymerization is usually carried out at temperatures of from 30 to 110° C., preferably from 50 to 100° C. Use of a pressure-resistant reactor or carrying out a continuous polymerization in a stirred tank cascade or flow tube is also possible.

During the emulsion polymerization, either the monomers can be metered directly into the initially taken mixture or they can be added in the form of an aqueous emulsion or mini emulsion to the polymerization batch. For this purpose, the monomers are emulsified in water with the use of the abovementioned customary emulsifiers.

The polymerization is carried out at a pH of from 2 to 9, preferably in the weakly acidic range at a pH from 2.2 to 5.5 or 3 to 5.5. The pH can be adjusted to the desired value before or during the polymerization with customary acids, such as hydrochloric acid, sulfuric acid or acetic acid, or with bases, such as sodium hydroxide solution, potassium hydroxide solution, ammonia, ammonium carbonate, etc.

In order to remove the residual monomers as substantially as possible from the finely divided, cationic, aqueous polymer dispersion, a postpolymerization is expediently carried out. For this purpose, an initiator from the group consisting of hydrogen peroxide, peroxides, hydroperoxides and/or azo initiators is added to the polymer dispersion after the end of the main polymerization. The combination of initiators with suitable reducing agents, such as, for example, ascorbic acid or sodium bisulfite, is likewise possible. Oil-soluble initiators which are sparingly soluble in water are preferably used, for example customary organic peroxides, such as dibenzoyl peroxide, ditert-butyl peroxide, tert-butyl hydroperoxide, cumyl hydroperoxide or biscyclohexyl peroxodicarbonate.

For the postpolymerization, the reaction mixture is heated, for example, to a temperature which corresponds to the temperature at which the main polymerization was carried out or which is up to 20° C., preferably up to 10° C., higher. The main polymerization is complete when the polymerization initiator has been consumed or the monomer conversion is, for example, at least 98%, preferably at least 99.5%. Tert-butyl hydroperoxide is preferably used for the postpolymerization. The postpolymerization is carried out, for example, in a temperature range from 35 to 100° C., in general from 45 to 95° C.

After the end of the polymerization, a complexing agent for heavy metal ions can be added to the polymer dispersion in an amount such that all heavy metal ions are bound as a complex.

The finely divided, cationic, aqueous polymer dispersions comprise dispersed particles having a mean particle size of from 20 to 500 nm, preferably from 50 to 250 nm. The mean particle size can be determined by means of methods known to the person skilled in the art, such as, for example, laser correlation spectroscopy, ultracentrifuging or HDC (hydrodynamic chromatography). A further measure of the particle size of the dispersed polymer particles is the LT value. For determining the LT value (light transmittance), the polymer dispersion to be investigated in each case is measured in 0.1% strength by weight aqueous dilution in a cell having an edge length of 2.5 cm using light of 600 nm wavelength and is compared with the corresponding transmittance of water under the same measuring conditions. The transmittance of water is specified as 100%. The more finely divided the dispersion, the higher is the LT value which is measured by the method described above. From the measured values, it is possible to calculate the mean particle size, cf. B. Verner, M. Bárta, B. Sedlácek, Tables of Scattering Functions for Spherical Particles, Prague, 1976, Edice Marco, Rada D-DATA, SVAZEK D-1.

The solids content of the finely divided, cationic, aqueous polymer dispersion is, for example, from 5 to 50% by weight and is preferably in the range from 15 to 40% by weight.

The finely divided, cationic, aqueous polymer dispersions described above are used as sizes for paper, board and cardboard. They can be used both as surface sizing agents and as engine sizing agents (also known as internal sizing agents) in the amounts customary in each case. The use as surface size is preferred. Here, the dispersions according to the invention can be processed by all methods suitable in the case of surface sizing. The polymer dispersions can be applied to the surface of the paper to be sized, for example, by means of a size press, film press or a gate-roll applicator. For use, the dispersion is usually added to the size press liquor in an amount of from 0.05 to 3% by weight, based on solid substance, and depends on the desired degree of sizing of the papers to be finished. Furthermore, the size press liquor may comprise further substances, such as, for example, starch, pigments, dyes, optical brighteners, biocides, paper strength agents, fixing agents, antifoams, retention aids and/or drainage aids. The amounts of polymer which are applied to the surface of paper products are, for example, from 0.005 to 1.0 g/m², preferably from 0.01 to 0.5 g/m². The sizing agents according to the present invention have the advantage that they are stable at high pH (e.g. above 7) and still provide good sizing effects. It may be desirable to include inorganic compounds such as poly aluminium chloride (PAC) or poly aluminium sulphate into the sizing formulation.

The invention is explained in more detail with reference to the following, non-limiting examples.

### EXAMPLES

The percentage data in the examples are percent by weight, unless evident otherwise from the context.

The particle sizes were determined by means of a high performance particle sizer (HPPS) from Malvern using an He—Ne laser (633 nm) at a scattering angle of 173°.

### Example 1

In a ground-joint 2 l flask equipped with stirrer and internal temperature measurement, 10.00 g (100% by weight) of Acetic acid, 16.25 g (80% by weight) of Dimethylaminoethyl acrylate methyl chloride, 1.00 g (100% by weight) of Bisomer® M PEG 350 MA (Methoxypolyethylene glycol 350 methacrylate), available from GEO Specialty Chemicals, and 240.00 g demineralized water were added to the charge and heated up to 85° C. under stirring. Then 0.40 g (10% by weight) Iron (II) sulfate heptahydrate solution in water was added. Subsequently the feed of 48.00 g (5% by weight) hydrogen peroxide solution (initiator) was started and fed over 180 min. Concomitantly a mixture of 36.00 g of Styrene, 48.00 g of tert-Butyl acrylate, 0.50 g of Terpinolene (90% by weight) and 2.00 g (100% by weight) of Acrylic acid was also fed over 150 min. At the end of the initiator feed the batch was further stirred for 60 min (post polymerisation) and then cooled down to the room temperature. A finely divided polymer dispersion having a solids content of 25% by weight and a particle size of 125 nm was obtained.

### Example 2

In a ground-joint 2 l flask equipped with stirrer and internal temperature measurement, 10.00 g (100% by weight) of Acetic acid, 16.25 g (80% by weight) of Dimethylaminoethyl acrylate methyl chloride, 3.00 g (100% by weight) of Bisomer® M PEG 350 MA (Methoxypolyethylene glycol 350 methacrylate), available from GEO Specialty Chemicals, and 240.00 g demineralized water were added to the charge and heated up to 85° C. under stirring. Then 0.40 g (10% by weight) Iron (II) sulfate heptahydrate solution in water was added. Subsequently the feed of 48.00 g (5% by weight) hydrogen peroxide solution (initiator) was started and fed over 180 min. Concomitantly a mixture of 34.00 g of Styrene, 48.00 g of tert-Butyl acrylate, 0.50 g of Terpinolene (90% by weight) and 2.00 g (100% by weight) of Acrylic acid was also fed over 150 min. At the end of the initiator feed the batch was further stirred for 60 min (post polymerisation) and then cooled down to the room temperature. A finely divided polymer dispersion having a solids content of 25% by weight and a particle size of 104 nm was obtained.

### Example 3

In a ground-joint 2 l flask equipped with stirrer and internal temperature measurement, 10.00 g (100% by weight) of Acetic acid, 20.00 g (50% by weight) of 1-Vinylimidazole dimethyl sulfate quaternary salt, 5.00 g (20% by weight) of emulsifier Lutensol® AT 25, available from BASF SE, and 120.00 g demineralized water were added to the charge and heated up to 85° C. under stirring. Then 0.40 g (10% by weight) Iron (II) sulfate heptahydrate solution in water was added. Subsequently the feed of 48.00 g (5% by weight) hydrogen peroxide solution (initiator) was started and fed over 180 min. Concomitantly a mixture of 40.00 g of Styrene, 40.00 g of tert-Butyl acrylate, 10.00 g of n-Butyl acrylate, 0.50 g of Terpinolene (90% by weight), 0.26 g (58% by weight) of emulsifier Lumiten® I-SC (sodium-di-ethyl-hexyl-sulfosuccinate), available from BASF SE, and 90.00 g demineralised water was also fed over 150 min. At the end of the initiator feed 10.00 g demineralized water were added to the reactor. The batch was further stirred for 60 min (post polymerisation) and then cooled down to the room temperature. A finely divided polymer dispersion having a solids content of 25% by weight and a particle size of 93 nm was obtained.

### Example 4

In a ground-joint 2 l flask equipped with stirrer and internal temperature measurement, 10.00 g (100% by weight) of Acetic acid, 20.00 g (50% by weight) of 1-Vinylimidazole dimethyl sulfate quaternary salt, 5.00 g (20% by weight) of emulsifier Lutensol® AT 25, available from BASF SE, and 120.00 g demineralized water were added to the charge and heated up to 85° C. under stirring. Then 0.40 g (10% by weight) Iron (II) sulfate heptahydrate solution in water was added. Subsequently the feed of 48.00 g (5% by weight) hydrogen peroxide solution (initiator) was started and fed over 180 min. Concomitantly a mixture of 40.00 g of Styrene, 50.00 g of tert-Butyl acrylate, 0.50 g of Terpinolene (90% by weight), 0.26 g (58% by weight) of emulsifier Lumiten® I-SC (sodium-di-ethyl-hexyl-sulfosuccinate), available from BASF SE, and 90.00 g demineralised water was also fed over 150 min. At the end of the initiator feed 10.00 g demineralized water were added to the reactor. The batch was further stirred for 60 min (post polymerisation) and then cooled down to the room temperature. A finely divided polymer dispersion having a solids content of 25% by weight and a particle size of 96 nm was obtained.

### Example 5

In a ground-joint 2 l flask equipped with stirrer and internal temperature measurement, 10.00 g (100% by weight) of Acetic acid, 30.00 g (50% by weight) of 1-Vinylimidazole dimethyl sulfate quaternary salt, 5.00 g (20% by weight) of emulsifier Lutensol® AT 25, available from BASF SE, and 120.00 g demineralized water were added to the charge and heated up to 85° C. under stirring. Then 0.40 g (10% by weight) Iron (II) sulfate heptahydrate solution in water was added. Subsequently the feed of 48.00 g (5% by weight) hydrogen peroxide solution (initiator) was started and fed over 180 min. Concomitantly a mixture of 35.00 g of Styrene, 50.00 g of tert-Butyl acrylate, 0.50 g of Terpinolene (90% by weight), 0.26 g (58% by weight) of emulsifier Lumiten® I-SC (sodium-di-ethyl-hexyl-sulfosuccinate), available from BASF SE, and 90.00 g demineralised water was also fed over 150 min. At the end of the initiator feed 10.00 g demineralized water were added to the reactor. The batch was further stirred for 60 min (post polymerisation) and then cooled down to the room temperature. A finely divided polymer dispersion having a solids content of 25% by weight and a particle size of 82 nm was obtained.

### Example 6

In a ground-joint 2 l flask equipped with stirrer and internal temperature measurement, 10.00 g (100% by weight) of Acetic acid, 24.00 g (50% by weight) of 1-Vinylimidazole dimethyl sulfate quaternary salt, 5.00 g (20% by weight) of emulsifier Lutensol AT 25 and 120.00 g demineralized water were added to the charge and heated up to 85° C. under stirring. Then 0.40 g (10% by weight) Iron (II) sulfate heptahydrate solution in water was added. Subsequently the feed of 48.00 g (5% by weight) hydrogen peroxide solution (initiator) was started and fed over 180 min. Concomitantly a mixture of 38.00 g of Styrene, 50.00 g of tert-Butyl acrylate, 0.56 g of Terpinolene (90% by weight), 0.26 g (58% by weight) of emulsifier Lumiten I-SC (sodium-di-ethyl-hexyl-sulfosuccinate) and 90.00 g demineralised water was also fed over 150 min. At the end of the initiator feed 10.00 g demineralized water were added to the reactor. The batch was further stirred for 60 min (post polymerisation) and then cooled down to the room temperature. A finely divided polymer dispersion having a solids content of 25% by weight and a particle size of 89 nm was obtained.

### Example 7

In a ground-joint 2 l flask equipped with stirrer and internal temperature measurement, 10.00 g (100% by weight) of Acetic acid, 12.00 g (50% by weight) of 1-Vinylimidazole dimethyl sulfate quaternary salt, 5.00 g (80% by weight) of Dimethylaminoethyl acrylate methyl chloride, 5.00 g (20% by weight) of emulsifier Lutensol® AT 25, available from BASF SE, and 120.00 g demineralized water were added to the charge and heated up to 85° C. under stirring. Then 0.40 g (10% by weight) Iron (II) sulfate heptahydrate solution in water was added. Subsequently the feed of 48.00 g (5% by weight) hydrogen peroxide solution (initiator) was started and fed over 180 min. Concomitantly a mixture of 40.00 g of Styrene, 50.00 g of tert-Butyl acrylate, 0.56 g of Terpinolene (90% by weight), 0.26 g (58% by weight) of emulsifier Lumiten® I-SC (sodium-diethyl-hexyl-sulfosuccinate), available from BASF SE, and 90.00 g demineralised water was also fed over 150 min. At the end of the initiator feed 10.00 g demineralized water were added to the reactor. The batch was further stirred for 60 min (post polymerisation) and then cooled down to the room temperature. A finely divided polymer dispersion having a solids content of 25% by weight and a particle size of 75 nm was obtained.

### Example 8

In a ground-joint 2 l flask equipped with stirrer and internal temperature measurement, 10.00 g (100% by weight) of Acetic acid, 16.00 g (50% by weight) of 1-Vinylimidazole dimethyl sulfate quaternary salt, 2.50 g (80% by weight) of Dimethylaminoethyl acrylate methyl chloride, 5.00 g (20% by weight) of emulsifier Lutensol® AT 25, available from BASF SE, and 120.00 g demineralized water were added to the charge and heated up to 85° C. under stirring. Then 0.40 g (10% by weight) Iron (II) sulfate heptahydrate solution in water was added. Subsequently the feed of 48.00 g (5% by weight) hydrogen peroxide solution (initiator) was started and fed over 180 min. Concomitantly a mixture of 40.00 g of Styrene, 40.00 g of tert-Butyl acrylate, 10.00 g of n-Butyl acrylate, 0.56 g of Terpinolene (90% by weight), 0.26 g (58% by weight) of emulsifier Lumiten® I-SC (sodium-di-ethyl-hexyl-sulfosuccinate), available from BASF SE, and 90.00 g demineralised water was also fed over 150 min. At the end of the initiator feed 10.00 g demineralized water were added to the reactor. The batch was further stirred for 60 min (post polymerisation) and then cooled down to the room temperature. A finely divided polymer dispersion having a solids content of 25% by weight and a particle size of 88 nm was obtained.

### Example 9

In a ground-joint 2 l flask equipped with stirrer and internal temperature measurement, 10.00 g (100% by weight) of Acetic acid, 16.00 g (50% by weight) of 1-Vinylimidazole dimethyl sulfate quaternary salt, 2.50 g (80% by weight) of Dimethylaminoethyl acrylate methyl chloride, 5.00 g (20% by weight) of emulsifier Lutensol® AT 25, available from BASF SE, and 120.00 g demineralized water were added to the charge and heated up to 85° C. under stirring. Then 0.40 g (10% by weight) Iron (II) sulfate heptahydrate solution in water was added. Subsequently the feed of 48.00 g (5% by weight) hydrogen peroxide solution (initiator) was started and fed over 180 min. Concomitantly a mixture of 40.00 g of Styrene, 30.00 g of tert-Butyl acrylate, 20.00 g of n-Butyl acrylate, 0.56 g of Terpinolene (90% by weight), 0.26 g (58% by weight) of emulsifier Lumiten® I-SC (sodium-di-ethyl-hexyl-sulfosuccinate), available from BASF SE, and 90.00 g demineralised water was also fed over 150 min. At the end of the initiator feed 10.00 g demineralized water were added to the reactor. The batch was further stirred for 60 min (post polymerisation) and then cooled down to the room temperature. A finely divided polymer dispersion having a solids content of 26% by weight and a particle size of 95 nm was obtained.

### Example 10

In a ground-joint 2 l flask equipped with stirrer and internal temperature measurement, 10.00 g (100% by weight) of Acetic acid, 10.00 g (50% by weight) of 1-Vinylimidazole dimethyl sulfate quaternary salt, 12.50 g (80% by weight) of Dimethylaminoethyl acrylate methyl chloride, 5.00 g (20% by weight) of emulsifier Lutensol® AT 25, available from BASF SE, and 120.00 g demineralized water were added to the charge and heated up to 85° C. under stirring. Then 0.40 g (10% by weight) Iron (II) sulfate heptahydrate solution in water was added. Subsequently the feed of 48.00 g (5% by weight) hydrogen peroxide solution (initiator) was started and fed over 180 min. Concomitantly a mixture of 40.00 g of Styrene, 30.00 g of tert-Butyl acrylate, 15.00 g of n-Butyl acrylate, 0.56 g of Terpinolene (90% by weight), 0.26 g (58% by weight) of emulsifier Lumiten® I-SC (sodium-di-ethyl-hexyl-sulfosuccinate), available from BASF SE, and 90.00 g demineralised water was also fed over 150 min. At the end of the initiator feed 10.00 g demineralized water were added to the reactor. The batch was further stirred for 60 min (post polymerisation) and then cooled down to the room temperature. A finely divided polymer dispersion having a solids content of 25% by weight and a particle size of 97 nm was obtained.

### Example 11

In a ground-joint 2 l flask equipped with stirrer and internal temperature measurement, 10.00 g (100% by weight) of Acetic acid, 16.25 g (80% by weight) of Dimethylaminoethyl acrylate methyl chloride, 1.25 g (80% by weight) of the monomer Plex® 6954-0, available from Evonik, and 130.00 g demineralized water were added to the charge and heated up to 85° C. under stirring. Then 0.40 g (10% by weight) Iron (II) sulfate heptahydrate solution in water was added. Subsequently the feed of 48.00 g (5% by weight) hydrogen peroxide solution (initiator) was started and fed over 180 min. Concomitantly a mixture of 30.00 g of Styrene, 50.00 g of tert-Butyl acrylate, 6.00 g of Acrylic acid, 0.56 g of Terpinolene (90% by weight), 0.26 g (58% by weight) of emulsifier Lumiten® I-SC (sodium-di-ethyl-hexyl-sulfosuccinate), available from BASF SE, and 90.00 g demineralised water was also fed over 150 min. At the end of the initiator feed 10.00 g demineralized water were added to the reactor. The batch was further stirred for 60 min (post polymerisation) and then cooled down to the room temperature. A finely divided polymer dispersion having a solids content of 25% by weight and a particle size of 115 nm was obtained.

### Example 12

In a ground-joint 2 l flask equipped with stirrer and internal temperature measurement, 10.00 g (100% by weight) of Acetic acid, 26.00 g (50% by weight) of 1-Vinylimidazole dimethyl sulfate quaternary salt, 5.00 g (20% by weight) of emulsifier Lutensol® AT 50, available from BASF SE, and 120.00 g demineralized water were added to the charge and heated up to 85° C. under stirring. Then 0.40 g (10% by weight) Iron (II) sulfate heptahydrate solution in water was added. Subsequently the feed of 48.00 g (5% by weight) hydrogen peroxide solution (initiator) was started and fed over 180 min. Concomitantly a mixture of 37.00 g of Styrene, 50.00 g of tert-Butyl acrylate, 0.56 g of Terpinolene (90% by weight), 0.26 g (58% by weight) of emulsifier Lumiten® I-SC (sodium-di-ethyl-hexyl-sulfosuccinate), available from BASF SE, and 90.00 g demineralised water was also fed over 150 min. At the end of the initiator feed 10.00 g demineralized water were added to the reactor. The batch was further stirred for 60 min (post polymerisation) and then cooled down to the room temperature. A finely divided polymer dispersion having a solids content of 25% by weight and a particle size of 83 nm was obtained.

### Example 13

In a ground-joint 2 l flask equipped with stirrer and internal temperature measurement, 10.00 g (100% by weight) of Acetic acid, 26.00 g (50% by weight) of 1-Vinylimidazole dimethyl sulfate quaternary salt, 5.00 g (20% by weight) of emulsifier Lutensol® AT 80, available from BASF SE, and 120.00 g demineralized water were added to the charge and heated up to 85° C. under stirring. Then 0.40 g (10% by weight) Iron (II) sulfate heptahydrate solution in water was added. Subsequently the feed of 48.00 g (5% by weight) hydrogen peroxide solution (initiator) was started and fed over 180 min. Concomitantly a mixture of 37.00 g of Styrene, 50.00 g of tert-Butyl acrylate, 0.56 g of Terpinolene (90% by weight), 0.26 g (58% by weight) of emulsifier Lumiten® I-SC (sodium-di-ethyl-hexyl-sulfosuccinate), available from BASF SE, and 90.00 g demineralised water was also fed over 150 min. At the end of the initiator feed 10.00 g demineralized water were added to the reactor. The batch was further stirred for 60 min (post polymerisation) and then cooled down to the room temperature. A finely divided polymer dispersion having a solids content of 24% by weight and a particle size of 80 nm was obtained.

### Example 14

In a ground-joint 2 l flask equipped with stirrer and internal temperature measurement, 10.00 g (100% by weight) of Acetic acid, 26.00 g (50% by weight) of 1-Vinylimidazole dimethyl sulfate quaternary salt, 1.00 g (100% by weight) of Bisomer® MPEG 350 MA (Methoxypolyethylene glycol 350 methacrylate), available from GEO Specialty Chemicals, and 125.00 g demineralized water were added to the charge and heated up to 85° C. under stirring. Then 0.40 g (10% by weight) Iron (II) sulfate heptahydrate solution in water was added. Subsequently the feed of 48.00 g (5% by weight) hydrogen peroxide solution (initiator) was started and fed over 180 min. Concomitantly a mixture of 36.00 g of Styrene, 50.00 g of tert-Butyl acrylate, 0.56 g of Terpinolene (90% by weight), 0.26 g (58% by weight) of emulsifier Lumiten® I-SC (sodium-di-ethyl-hexyl-sulfosuccinate), available from BASF SE, and 90.00 g demineralised water was also fed over 150 min. At the end of the initiator feed 10.00 g demineralized water were added to the reactor. The batch was further stirred for 60 min (post polymerisation) and then cooled down to the room temperature. A finely divided polymer dispersion having a solids content of 24.5% by weight and a particle size of 202 nm was obtained.

### Example 15

In a ground-joint 2 l flask equipped with stirrer and internal temperature measurement, 10.00 g (100% by weight) of Acetic acid, 11.25 g (80% by weight) of Dimethylaminoethyl acrylate methyl chloride, 15.00 g (20% by weight) of emulsifier Lutensol® AT 18, available from BASF SE, and 120.00 g demineralized water were added to the charge and heated up to 85° C. under stirring. Then 0.40 g (10% by weight) Iron (II) sulfate heptahydrate solution in water was added. Subsequently the feed of 48.00 g (5% by weight) hydrogen peroxide solution (initiator) was started and fed over 180 min. Concomitantly a mixture of 35.00 g of Styrene, 51.00 g of tert-Butyl acrylate, 5.00 g of Acrylic acid, 0.56 g of Terpinolene (90% by weight), 0.26 g (58% by weight) of emulsifier Lumiten® I-SC (sodium-di-ethyl-hexyl-sulfosuccinate), available from BASF SE, and 90.00 g demineralised water was also fed over 150 min. At the end of the initiator feed 10.00 g demineralized water were added to the reactor. The batch was further stirred for 60 min (post polymerisation) and then cooled down to the room temperature. A finely divided polymer dispersion having a solids content of 25.6% by weight and a particle size of 86 nm was obtained.

### Example 16

In a ground-joint 2 l flask equipped with stirrer and internal temperature measurement, 5.00 g (100% by weight) of Acetic acid, 26.00 g (50% by weight) of 1-Vinylimidazole dimethyl sulfate quaternary salt, 5.00 g (20% by weight) of emulsifier Lutensol® AT 25, available from BASF SE, and 120.00 g demineralized water were added to the charge and heated up to 85° C. under stirring. Then 0.40 g (10% by weight) Iron (II) sulfate heptahydrate solution in water was added. Subsequently the feed of 48.00 g (5% by weight) hydrogen peroxide solution (initiator) was started and fed over 180 min. Concomitantly a mixture of 37.00 g of Styrene, 50.00 g of tert-Butyl acrylate, 0.56 g of Terpinolene (90% by weight), 0.26 g (58% by weight) of emulsifier Lumiten® I-SC (sodium-di-ethyl-hexyl-sulfosuccinate), available from BASF SE, and 90.00 g demineralised water was also fed over 150 min. At the end of the initiator feed 10.00 g demineralized water were added to the reactor. The batch was further stirred for 60 min (post polymerisation) and then cooled down to the room temperature. A finely divided polymer dispersion having a solids content of 25% by weight and a particle size of 80 nm was obtained.

### Example 17

In a ground-joint 2 l flask equipped with stirrer and internal temperature measurement, 5.00 g (100% by weight) of Formic acid, 26.00 g (50% by weight) of 1-Vinylimidazole dimethyl sulfate quaternary salt, 5.00 g (20% by weight) of emulsifier Lutensol® AT 25, available from BASF SE, and 120.00 g demineralized water were added to the charge and heated up to 85° C. under stirring. Then 0.40 g (10% by weight) Iron (II) sulfate heptahydrate solution in water was added. Subsequently the feed of 48.00 g (5% by weight) hydrogen peroxide solution (initiator) was started and fed over 180 min. Concomitantly a mixture of 37.00 g of Styrene, 50.00 g of tert-Butyl acrylate, 0.56 g of Terpinolene (90% by weight), 0.26 g (58% by weight) of emulsifier Lumiten® I-SC (sodium-di-ethyl-hexyl-sulfosuccinate), available from BASF SE, and 90.00 g demineralised water was also fed over 150 min. At the end of the initiator feed 10.00 g demineralized water were added to the reactor. The batch was further stirred for 60 min (post polymerisation) and then cooled down to the room temperature. A finely divided polymer dispersion having a solids content of 24.7% by weight and a particle size of 87 nm was obtained.

### Example 18

In a ground-joint 2 l flask equipped with stirrer and internal temperature measurement, 10.00 g (100% by weight) of Formic acid, 26.00 g (50% by weight) of 1-Vinylimidazole dimethyl sulfate quaternary salt, 5.00 g (20% by weight) of emulsifier Lutensol® AT 25, available from BASF SE, 120.00 g demineralized water were added to the charge and heated up to 85° C. under stirring. Then 0.40 g (10% by weight) Iron (II) sulfate heptahydrate solution in water was added. Subsequently the feed of 48.00 g (5% by weight) hydrogen peroxide solution (initiator) was started and fed over 180 min. Concomitantly a mixture of 37.00 g of Styrene, 50.00 g of tert-Butyl acrylate, 0.56 g of Terpinolene (90% by weight), 0.26 g (58% by weight) of emulsifier Lumiten® I-SC (sodium-di-ethyl-hexyl-sulfosuccinate), available from BASF SE, and 90.00 g demineralised water was also fed over 150 min. At the end of the initiator feed 10.00 g demineralized water were added to the reactor. The batch was further stirred for 60 min (post polymerisation) and then cooled down to the room temperature. A finely divided polymer dispersion having a solids content of 24.5% by weight and a particle size of 89 nm was obtained.

### Example 19

In a ground-joint 2 l flask equipped with stirrer and internal temperature measurement, 10.00 g (100% by weight) of Acetic acid, 26.00 g (50% by weight) of 1-Vinylimidazole dimethyl sulfate quaternary salt, 5.00 g (20% by weight) of emulsifier Lutensol® AT 25, available from BASF SE, and 120.00 g demineralized water were added to the charge and heated up to 85° C. under stirring. Then 0.40 g (10% by weight) Iron (II) sulfate heptahydrate solution in water was added. Subsequently the feed of 48.00 g (5% by weight) hydrogen peroxide solution (initiator) was started and fed over 180 min. Concomitantly a mixture of 37.00 g of Styrene, 50.00 g of tert-Butyl acrylate, 0.56 g of Terpinolene (90% by weight), 0.26 g (58% by weight) of emulsifier Lumiten® I-SC (sodium-di-ethyl-hexyl-sulfosuccinate), available from BASF SE, and 90.00 g demineralised water was also fed over 150 min. At the end of the initiator feed 10.00 g demineralized water were added to the reactor. The batch was further stirred for 60 min (post polymerisation) and then cooled down to the room temperature. A finely divided polymer dispersion having a solids content of 25% by weight and a particle size of 82 nm was obtained.

### Example 20

In a ground-joint 2 l flask equipped with stirrer and internal temperature measurement, 10.00 g (100% by weight) of Acetic acid, 16.25 g (80% by weight) of Dimethylaminoethyl acrylate methyl chloride, 1.00 g (100% by weight) of Bisomer® M PEG 350 MA (Methoxypolyethylene glycol 350 methacrylate), available from GEO Specialty Chemicals, and 135.00 g demineralized water were added to the charge and heated up to 85° C. under stirring. Then 0.40 g (10% by weight) Iron (II) sulfate heptahydrate solution in water was added. Subsequently the feed of 48.00 g (5% by weight) hydrogen peroxide solution (initiator) was started and fed over 180 min. Concomitantly a mixture of 30.00 g of Styrene, 50.00 g of tert-Butyl acrylate, 6.00 g of Acrylic acid, 0.56 g of Terpinolene (90% by weight), 0.26 g (58% by weight) of emulsifier Lumiten® I-SC (sodium-di-ethyl-hexyl-sulfosuccinate), available from BASF SE, and 90.00 g demineralised water was also fed over 150 min. At the end of the initiator feed 10.00 g demineralized water were added to the reactor. The batch was further stirred for 60 min (post polymerisation) and then cooled down to the room temperature. A finely divided polymer dispersion having a solids content of 25% by weight and a particle size of 133 nm was obtained.

### Example 21

In a ground-joint 2 l flask equipped with stirrer and internal temperature measurement, 10.00 g (100% by weight) of Acetic acid, 11.25 g (80% by weight) of Dimethylaminoethyl acrylate methyl chloride, 1.00 g (100% by weight) of Bisomer® M PEG 350 MA (Methoxypolyethylene glycol 350 methacrylate), available from GEO Specialty Chemicals, and 135.00 g demineralized water were added to the charge and heated up to 85° C. under stirring. Then 0.40 g (10% by weight) Iron (II) sulfate heptahydrate solution in water was added. Subsequently the feed of 48.00 g (5% by weight) hydrogen peroxide solution (initiator) was started and fed over 180 min. Concomitantly a mixture of 34.00 g of Styrene, 51.00 g of tert-Butyl acrylate, 5.00 g of Acrylic acid, 0.56 g of Terpinolene (90% by weight), 0.26 g (58% by weight) of emulsifier Lumiten® I-SC (sodium-di-ethyl-hexyl-sulfosuccinate), available from BASF SE, and 90.00 g demineralised water was also fed over 150 min. At the end of the initiator feed 10.00 g demineralized water were added to the reactor. The batch was further stirred for 60 min (post polymerisation) and then cooled down to the room temperature. A finely divided polymer dispersion having a solids content of 25% by weight and a particle size of 101 nm was obtained.

### Example 22

In a ground-joint 2 l flask equipped with stirrer and internal temperature measurement, 10.00 g (100% by weight) of Acetic acid, 16.25 g (80% by weight) of Dimethylaminoethyl acrylate methyl chloride, 2.00 g (100% by weight) of Bisomer® M PEG 350 MA (Methoxypolyethylene glycol 350 methacrylate), available from GEO Specialty Chemicals, and 240.00 g demineralized water were added to the charge and heated up to 85° C. under stirring. Then 0.40 g (10% by weight) Iron (II) sulfate heptahydrate solution in water was added. Subsequently the feed of 48.00 g (5% by weight) hydrogen peroxide solution (initiator) was started and fed over 180 min. Concomitantly a mixture of 15.00 g of Styrene, 48.00 g of tert-Butyl acrylate, 6.00 g of Acrylic acid, 9.00 g of Methyl acrylate, 7.00 g of Methyl methacrylate and 0.50 g of Terpinolene (90% by weight) was also fed over 150 min. At the end of the initiator feed the batch was further stirred for 60 min (post polymerisation) and then cooled down to the room temperature. A finely divided polymer dispersion having a solids content of 25% by weight and a particle size of 101 nm was obtained.

### Example 23

In a ground-joint 2 l flask equipped with stirrer and internal temperature measurement, 10.00 g (100% by weight) of Acetic acid, 16.25 g (80% by weight) of Dimethylaminoethyl acrylate methyl chloride, 2.00 g (100% by weight) of Bisomer® M PEG 350 MA (Methoxypolyethylene glycol 350 methacrylate), available from GEO Specialty Chemicals, and 240.00 g demineralized water were added to the charge and heated up to 85° C. under stirring. Then 0.40 g (10% by weight) Iron (II) sulfate heptahydrate solution in water was added. Subsequently the feed of 48.00 g (5% by weight) hydrogen peroxide solution (initiator) was started and fed over 180 min. Concomitantly a mixture of 17.00 g of Styrene, 48.00 g of tert-Butyl acrylate, 4.00 g of Acrylic acid, 9.00 g of Methyl acrylate, 7.00 g of Methyl methacrylate and 0.50 g of Terpinolene (90% by weight) was also fed over 150 min. At the end of the initiator feed the batch was further stirred for 60 min (post polymerisation) and then cooled down to the room temperature. A finely divided polymer dispersion having a solids content of 25% by weight and a particle size of 95 nm was obtained.

### Example 24

In a ground-joint 2 l flask equipped with stirrer and internal temperature measurement, 10.00 g (100% by weight) of Acetic acid, 10.00 g (50% by weight) of 1-Vinylimidazole dimethyl sulfate quaternary salt, 15.00 g (20% by weight) of emulsifier Lutensol® AT 25, available from BASF

SE, and 120.00 g demineralized water were added to the charge and heated up to 85° C. under stirring. Then 0.40 g (10% by weight) Iron (II) sulfate heptahydrate solution in water was added. Subsequently the feed of 48.00 g (5% by weight) hydrogen peroxide solution (initiator) was started and fed over 180 min. Concomitantly a mixture of 45.00 g of Styrene, 50.00 g of tert-Butyl acrylate, 0.56 g of Terpinolene (90% by weight), 0.26 g (58% by weight) of emulsifier Lumiten® I-SC (sodium-di-ethyl-hexyl-sulfosuccinate), available from BASF SE, and 90.00 g demineralised water was also fed over 150 min. At the end of the initiator feed 10.00 g demineralized water were added to the reactor. The batch was further stirred for 60 min (post polymerisation) and then cooled down to the room temperature. A finely divided polymer dispersion having a solids content of 25.4% by weight and a particle size of 116 nm was obtained.

### Example 25

In a ground-joint 2 l flask equipped with stirrer and internal temperature measurement, 10.00 g (100% by weight) of Acetic acid, 21.25 g (80% by weight) of Dimethylaminoethyl acrylate methyl chloride, 2.00 g (100% by weight) of Bisomer® M PEG 350 MA (Methoxypolyethylene glycol 350 methacrylate), available from GEO Specialty Chemicals, and 240.00 g demineralized water were added to the charge and heated up to 85° C. under stirring. Then 0.40 g (10% by weight) Iron (II) sulfate heptahydrate solution in water was added. Subsequently the feed of 48.00 g (5% by weight) hydrogen peroxide solution (initiator) was started and fed over 180 min. Concomitantly a mixture of 31.00 g of Styrene, 48.00 g of tert-Butyl acrylate, 2.00 g of Acrylic acid and 0.50 g of Terpinolene (90% by weight) was also fed over 150 min. At the end of the initiator feed the batch was further stirred for 60 min (post polymerisation) and then cooled down to the room temperature. A finely divided polymer dispersion having a solids content of 25% by weight and a particle size of 96 nm was obtained.

### Example 26

In a ground-joint 2 l flask equipped with stirrer and internal temperature measurement, 15.00 g (100% by weight) of Acetic acid, 30.00 g (50% by weight) of 1-Vinylimidazole dimethyl sulfate quaternary salt, 1.50 g (20% by weight) of emulsifier Lutensol® AT 25, available from BASF SE, and 97.50 g demineralized water were added to the charge and heated up to 85° C. under stirring. Then 0.60 g (10% by weight) Iron (II) sulfate heptahydrate solution in water was added. Subsequently a feed of 72.00 g (5% by weight) hydrogen peroxide solution (initiator) was started and fed over 180 min. Concomitantly a mixture of 60.00 g of Styrene, 60.00 g of tert-Butyl acrylate, 15.00 g of n-Butyl acylate and 0.83 g of Terpinolene (90% by weight) was also fed over 150 min. At the end of the initiator feed 15.00 g demineralized water were added and the batch was further stirred for 30 min (post poymerisation) and then within 30 min the polymerization mixture was cooled down to 50° C. Afterwards 3.00 g (10% by weight) of t-Butyl hydroperoxyde were added, followed by 30 min post polymerisation. Then the polymerisation mixture was cooled down further to the room temperature. A finely divided polymer dispersion having a solids content of 43% by weight and a particle size of 178 nm was obtained.

Testing of performance characteristics of polymer dispersions obtained according to the examples and the comparative example.

The pH stability tests were carried out by adding a solution of NaOH (25% wt) up to pH>7. The samples which are stable (during the pH adjustment no coagulation can be observed) are beeing stored at 25° C. for 1 h. The dispersion is then pH stable, when it is not affected after this treatment—no coagulum can be observed.

### Performance Testing of Polymer Dispersions:

To test the surface-sizing effect in use, the inventive dispersions and the comparative dispersions were applied by means of a laboratory size press to the test paper (100% reclaimed paper, 80 g/m2 basis weight, unsized). The aqueous solution of a degraded corn starch was adjusted to the desired concentration. The dispersions to be tested were then added to the starch solution such that the size press liquor comprised 60 g/l of a degraded corn starch, 0.3-0.5 g/l of the dispersions (see Table 1) and 2 g/L of Polyaluminum chloride (Sachtoklar® 39 available from Sachtleben Wasser Chemie).

The sizing effect of the dispersions 1 to 26 obtained as described in Examples 1 to 26 and Comparative example 1 was then determined by surface application to the unsized test paper. To this end, the paper was passed twice through the size press, an average weight increase of about 65% being achieved.

The surface-sized papers were dried on a drying cylinder at 90° C. The papers were subsequently stored overnight in a conditioned room (23° C., 50% relative humidity) before the degree of sizing was determined.

To determine the degree of sizing of the surface-sized papers, the Cobb60 and Cobb120 values were determined according to DIN 53 132. The Cobb60 value is defined as the water absorption of the paper sheet in g/m2 after contact with water and a contact time of 60 s (or 120 s in the case of the Cobb120 value). The lower the Cobb value, the better the sizing effect of the dispersion used.

The sizing and stability results are shown in Table 1.

TABLE 1
Cobb values - permanent cationic dispersions

| | Cobb 60-Value | | | Cobb 120-Value | |
|---|---|---|---|---|---|
| | [g/m²] | | | [g/m²] | Stable |
| | Dose | | | | dispersion at |
| | 0.3 | 0.4 | 0.5 | 0.5 | pH = 7 @25° C. |
| Comparative | 43 | 30 | 22 | 32 | No |
| Example 1 | | | | | |
| Basoplast ® | | | | | |
| 285S | | | | | |
| Example 1 | 44 | 38 | 30 | 62 | Yes |
| Example 2 | 39 | 34 | 30 | 45 | Yes |
| Example 3 | 40 | 35 | 24 | 33 | yes |
| Example 4 | 45 | 39 | 26 | 39 | yes |
| Example 5 | 60 | 33 | 28 | 49 | yes |
| Example 6 | 52 | 34 | 29 | 36 | yes |
| Example 7 | 34 | 29 | 26 | 44 | yes |
| Example 8 | 39 | 33 | 27 | 47 | yes |
| Example 9 | 59 | 32 | 24 | 63 | yes |
| Example 10 | 53 | 44 | 32 | 61 | yes |
| Example 11 | 92 | 40 | 37 | 91 | yes |
| Example 12 | 34 | 33 | 31 | 49 | yes |
| Example 13 | 39 | 36 | 30 | 54 | yes |
| Example 14 | 56 | 38 | 33 | 74 | yes |
| Example 15 | 50 | 48 | 40 | 52 | yes |
| Example 16 | 39 | 32 | 24 | 47 | yes |
| Example 17 | 49 | 40 | 32 | 64 | yes |
| Example 18 | 59 | 36 | 27 | 54 | yes |
| Example 19 | 50 | 34 | 24 | 50 | yes |
| Example 20 | 42 | 40 | 39 | 92 | yes |
| Example 21 | 52 | 46 | 40 | 76 | yes |
| Example 22 | 58 | 42 | 37 | 75 | yes |
| Example 23 | 48 | 32 | 31 | 55 | yes |
| Example 24 | 53 | 30 | 28 | 66 | yes |
| Example 25 | 40 | 37 | 33 | 48 | Yes |
| Example 26 | 36 | 30 | 26 | 57 | Yes |

1. A finely divided, cationic, aqueous polymer dispersion which is obtained by emulsion polymerisation of ethylenically unsaturated monomers in a continuous phase containing an aqueous liquid in which the emulsion polymerisation is carried out, in the presence of polymerisation initiators, of a combination of monomers comprising
(a) from 0 to less than 60% by weight of at least one optionally substituted styrene,
(b) from greater than 0 to 80% of at least one C₁-C₁₂-alkyl acrylate and/or at least one C₁-C₁₂-alkyl methacrylate,
(c) from 0 to 10% by weight of at least one ethylenically unsaturated monomer comprising at least one acid group,
(d) from 5 to 20% by weight of at least one ethylenically unsaturated monomer comprising a cationic group, and
(e) from 0 to 50% by weight of at least one non-ionic ethylenically unsaturated monomer differing from (a), (b), (c), and (d),
the sum of (a)+(b)+(c)+(d)+(e) being 100% by weight,
and the aqueous liquid contains from 0 to 4% by weight based on the weight of the combination of monomers of at least one emulsifier,
in which the emulsion polymerisation is carried out optionally in the presence of at least one terpene containing compound.

2. The finely divided, cationic, aqueous polymer dispersion according to claim 1, wherein the emulsion polymerisation is of a combination of monomers comprising
(a) from 10 to 50% by weight of styrene,
(b) from 25 to 70% by weight of at least one C₁-C₁₂-alkyl acrylate and/or at least one C₁-C₁₂-alkyl methacrylate,
(c) from 0 to 10% by weight of at least one ethylenically unsaturated monomer comprising at least one carboxylic acid group,
(d) from 3 to less than 20% of at least one ethylenically unsaturated monomer comprising at least one quaternary ammonium group,
(e) from 0 to 20% by weight of at least one non-ionic ethylenically unsaturated monomer differing from (a), (b), (c), and (d),
the sum of (a)+(b)+(c)+(d) (e) being 100% by weight,
and the aqueous liquid contains from 0.5 to 3.5% by weight based on the weight of the combination of monomers of at least one emulsifier,
in which the emulsion polymerisation is carried out optionally in the presence of at least one terpene containing compound.

3. The finely divided, cationic, aqueous polymer dispersion according to claim 1, wherein the emulsion polymerisation is of a combination of monomers comprising
(a) from 10 to 50% by weight of styrene,
(b) from 25 to 70% by weight of at least one C₁-C₄-alkyl acrylate and/or at least one C₁-C₄-alkyl methacrylate,
(c) from 0 to 10% by weight of acrylic acid or methacrylic acid,
(d) from 5 to 15% of at least one ethylenically unsaturated monomer comprising at least one quaternary ammonium group, selected from the group consisting of a quaternary ammonium salt of dialkyl amino alkyl acrylate, a quaternary ammonium salt of dialkyl amino alkyl methacrylate and a quaternary ammonium salt of vinyl imidazole.
(e) from 0 to 10% by weight of at least one non-ionic ethylenically unsaturated monomer differing from (a), (b), (c), and (d),
the sum of (a)+(b)+(c)+(d)+(e) being 100% by weight,
and the aqueous liquid contains from 0.5 to 3.5% by weight based on the weight of the combination of monomers of at least one emulsifier,
in which the emulsion polymerisation is carried out optionally in the presence of at least one terpene containing compound.

4. The finely divided, cationic, aqueous polymer dispersion according to claim 1, wherein the emulsion polymerisation is of a combination of monomers comprising
(a) from 10 to 50% by weight of styrene,
(b) from 25 to 70% by weight of at least one C₁-C₄-alkyl acrylate and/or at least one C₁-C₄-alkyl methacrylate,
(c) from 1 to 10% by weight of acrylic acid or methacrylic acid,
(d) from 5 to 15% of a quaternary ammonium salt of dimethyl amino ethyl acrylate.
the sum of (a)+(b)+(c)+(d) being 100% by weight,
and the aqueous liquid contains from 0.5 to 3.5% by weight based on the weight of the combination of monomers of at least one emulsifier,
in which the emulsion polymerisation is carried out in the presence of at least 0.01% by weight based on the weight of the combination of components (a)+(b)+(c)+(d) of at least one terpene containing compound.

5. The finely divided, cationic, aqueous polymer dispersion according to claim 1, wherein the emulsion polymerisation is of a combination of monomers comprising
(a) from 15 to 50% by weight of styrene,
(b) from 35 to 70% by weight of at least one C₁-C₄-alkyl acrylate and/or at least one C₁-C₄-alkyl methacrylate,
(d) from 5 to 15% of a quaternary ammonium salt of vinyl imidazole, optionally in combination with a quaternary ammonium salt of dimethyl amino ethyl acrylate.
the sum of (a)+(b)+(d) being 100% by weight,
and the aqueous liquid contains from 0.5 to 3.5% by weight based on the weight of the combination of monomers of at least one emulsifier,
in which the emulsion polymerisation is carried out in the presence of at least 0.01% by weight based on the weight of the combination of components (a)+(b)+(d) of at least one terpene containing compound.

6. The finely divided, cationic, aqueous polymer dispersion according to claim 1, wherein the emulsifier is present and comprises a compound having the formula
R′—O—(CH₂—CH₂—O—)ₓH
in which R′ is an alkyl group of at least 12 carbon atoms, and x is at least 12.

7. The finely divided, cationic, aqueous polymer dispersion according to claim 1, wherein the emulsifier is present and comprises a polymerisable compound having the formula
R″(—O—CH₂—CH₂)ₓM
in which R″ is an alkyl group of at least one carbon atom, and M is a polymerisable moiety containing an ethylenically unsaturated group.

8. The finely divided, cationic, aqueous polymer dispersion according to claim 1, in which the terpene containing compound is present in an amount of from 0.01 to 5% by weight, based on the weight of the combination of components (a)+(b) (c) (d)+(e).

9. A process for the preparation of the finely divided, cationic, aqueous polymer dispersion according to claim 1, comprising emulsion polymerisation of ethylenically unsaturated monomers in a continuous phase containing an aqueous liquid in which the emulsion polymerisation is carried out, in the presence of polymerisation initiators, of a combination of monomers comprising
(a) from 0 to less than 60% by weight of at least one optionally substituted styrene,
(b) from greater than 0 to 80% of at least one C₁-C₁₂-alkyl acrylate and/or at least one C₁-C₁₂-alkyl methacrylate,
(c) from 0 to 10% by weight of at least one ethylenically unsaturated monomer comprising at least one acid group,
(d) from 5 to 20% by weight of at least one ethylenically unsaturated monomer comprising a cationic group, and
(e) from 0 to 50% by weight of at least one non-ionic ethylenically unsaturated monomer differing from (a), (b), (c), and (d),
the sum of (a)+(b)+(c)+(d)+(e) being 100% by weight,
and the aqueous liquid contains from 0 to 4% by weight based on the weight of the combination of monomers of at least one emulsifier,
in which the emulsion polymerisation is carried out optionally in the presence of at least one terpene containing compound.

10. A sizing agent comprising the finely divided, cationic, aqueous polymer dispersions according to claim 1.
